(19) United States
(12) Patent Application Publication
(10) Pub. No.: US 2013/0089308 A1
(43) Pub. Date: Apr. 11, 2013

(54) MULTIMEDIA DEVICE FOR REDUCING A LOAD

(71) Applicants: Byung-youn Song, Suwon-si (KR); Nag-eui Choi, Suwon-si (KR)

(72) Inventors: Byung-youn Song, Suwon-si (KR); Nag-eui Choi, Suwon-si (KR)

(21) Appl. No.: 13/610,482

(22) Filed: Sep. 11, 2012

(30) Foreign Application Priority Data
Oct. 6, 2011 (KR) 10-2011-0101838

(51) Int. Cl. H04N 5/917

(52) U.S. Cl. 386/355; 386/E05.007

(57) ABSTRACT

Provided is a multimedia device. The multimedia device includes a multimedia signal processing apparatus for decoding data input from the outside based on an Operating System (OS) and outputting the decoded data as a first multimedia signal. The multimedia device also includes an Optical Disc Drive (ODD) apparatus for acquiring data from an optical disc, decoding the acquired data, and outputting the decoded data as a second multimedia signal. The multimedia device also includes an output switch for selectively outputting one of the first multimedia signal and the second multimedia signal.

CROSS-REFERENCE TO RELATED APPLICATION(S)

This application claims the benefit under 35 USC §119(a) of Korean Patent Application No. 10-2011-0101838, filed on Oct. 6, 2011, in the Korean Intellectual Property Office, the entire disclosure of which is incorporated herein by reference for all purposes.

### BACKGROUND

1. Field

The following description relates to a multimedia device, and more particularly, to a multimedia device that has an optical disc reproducing apparatus.

2. Description of the Related Art

Due to the installation of smart functions, such as the Internet, games, and Social Network Services (SNS), into multimedia devices such as Blu-ray players, set-top boxes, and the like, a Central Processing Unit (CPU) capable of providing an operating environment for smart functions based on an Operating System (OS) has been used. Typically, CPUs of a Personal Computer (PC), which are mass-produced by various semiconductor chip manufacturers, are used.

A common PC employs an Optical Disc Drive (ODD) for reproducing media. In general, communication between a main body of the PC and the ODD is performed using a Serial Advanced Technology Attachment (SATA) interface. Thus, in conventional PCs, raw data read by an ODD is transmitted to a CPU in the main body, decoded, reproduced as a video signal, and displayed. To perform these tasks, conventional PCs require a high-specification CPU and a high-specification memory to decode high-resolution and high-definition video. thereby causing customers to buy a high-specification PC. However, the cost of such high-specification PCs can be very expensive.

### SUMMARY

In an aspect, there is provided a multimedia device including a multimedia signal processing apparatus configured to decode data input from an outside source based on an Operating System (OS) and to output the decoded data as a first multimedia signal, an Optical Disc Drive (ODD) apparatus configured to acquire data from an optical disc, to decode the acquired data, and to output the decoded data as a second multimedia signal, and an output switch configured to receive the first multimedia signal and the second multimedia signal and to selectively output one of the first multimedia signal and the second multimedia signal.

The first and second multimedia signals may each satisfy a display interface standard.

The display interface standard may comprise at least one of a High Definition Multimedia Interface (HDMI) standard, a Digital Visual Interface (DVI) standard, a DisplayPort (DP) standard, and a Video Graphics Array (VGA) standard.

The multimedia signal processing apparatus, the ODD apparatus, and the output switch may be accommodated in a single housing.

The multimedia signal processing apparatus may comprise an ODD controller configured to control the ODD apparatus, a main interface configured to receive raw data from the outside source, a main decoder configured to process input multimedia data to decode the input multimedia data into the first multimedia signal, an Operating System Device (OSD) configured to provide an operating environment of the ODD controller and the main decoder based on the OS, and a first output interface configured to output the first multimedia signal processed by the main decoder.

The ODD controller may comprise an ODD master interface configured to transmit and receive data to and from the ODD apparatus.

The ODD master interface may comprise at least one of a Universal Serial Bus (USB) interface, an Advanced Technology Attachment (ATA) interface, and a Serial Advanced Technology Attachment (SATA) interface.

The main interface may comprise at least one of a USB interface, a Parallel ATA (PATA) interface, a SATA interface, a flash media interface, an Ethernet interface, a Wi-Fi interface, and a Bluetooth interface.

The main decoder may comprise at least one of hardware codecs and software codecs corresponding to a plurality of multimedia data standards.

The OSD may comprise a Central Processing Unit (CPU) and a memory for providing the operating environment of the ODD controller and the main decoder based on the OS.

The first output interface may satisfy at least one of the HDMI interface standard, the DVI standard, the DP standard, and the VGA standard.

The ODD apparatus may comprise an optical pickup configured to read a signal from an optical disc, a front-end module configured to control the optical pickup and processing the signal read by the optical pickup into a digital signal, and a back-end module configured to decode the digital signal processed by the front-end module and output the decoded digital signal as the second multimedia signal.

The front-end module may comprise a servo controller configured to control the optical pickup, and a Radio Frequency (RF) signal processor configured to convert an RF signal read by the optical pickup to a digital signal.

The back-end module may comprise an ODD decoder configured to decode the digital signal received from the front-end module into the second multimedia signal, and a second output interface configured to output the second multimedia signal.

The multimedia device may further comprise a multimedia output apparatus configured to receive a multimedia signal selected by and output from the output switch.

The multimedia output apparatus may comprise a terminal satisfying at least one of the HDMI interface standard, the DVI standard, the DP standard, and the VGA standard.

In an aspect, there is provided a smart TV including a broadcast data processing apparatus configured to broadcast data input from an outside source based on an Operating System (OS) and to output the decoded broadcast data as a first multimedia signal, an Optical Disc Drive (ODD) apparatus configured to acquire data from an optical disc, to decode the acquired data, and to output the decoded data as a second multimedia signal, an output switch configured to receive the first multimedia signal and the second multimedia signal and to selectively output one of the first multimedia signal and the second multimedia signal, and a display and audio output apparatus configured to receive the multimedia signal selected by and output from the output switch and to render the multimedia.

The first and second multimedia signals may satisfy at least one of a High Definition Multimedia Interface (HDMI) standard, a Digital Visual Interface (DVI) standard, a DisplayPort (DP) standard, and a Video Graphics Array (VGA) standard.

In an aspect, there is provided an optical disc drive for a multimedia device, the optical disc drive including an optical pickup configured to read information from an optical disc, a front-end module configured to process a radio frequency (RF) signal received from the optical pickup, and a back-end module configured to decode a processed digital signal received from the front-end module to generate a multimedia signal.

The multimedia signal generated by the back-end module may be in a format that is capable of being rendered by the multimedia device without further processing by a central processing unit (CPU) of the multimedia device.

Other features and aspects may be apparent from the following detailed description, the drawings, and the claims.

### BRIEF DESCRIPTION OF THE DRAWINGS

FIG. 1 is a diagram illustrating an example of a multimedia device.

FIG. 2 is a diagram illustrating an example of a multimedia signal processing apparatus in the multimedia device of FIG. 1.

FIG. 3 is a diagram illustrating an example of an Optical Disc Drive (ODD) apparatus included in the multimedia device of FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

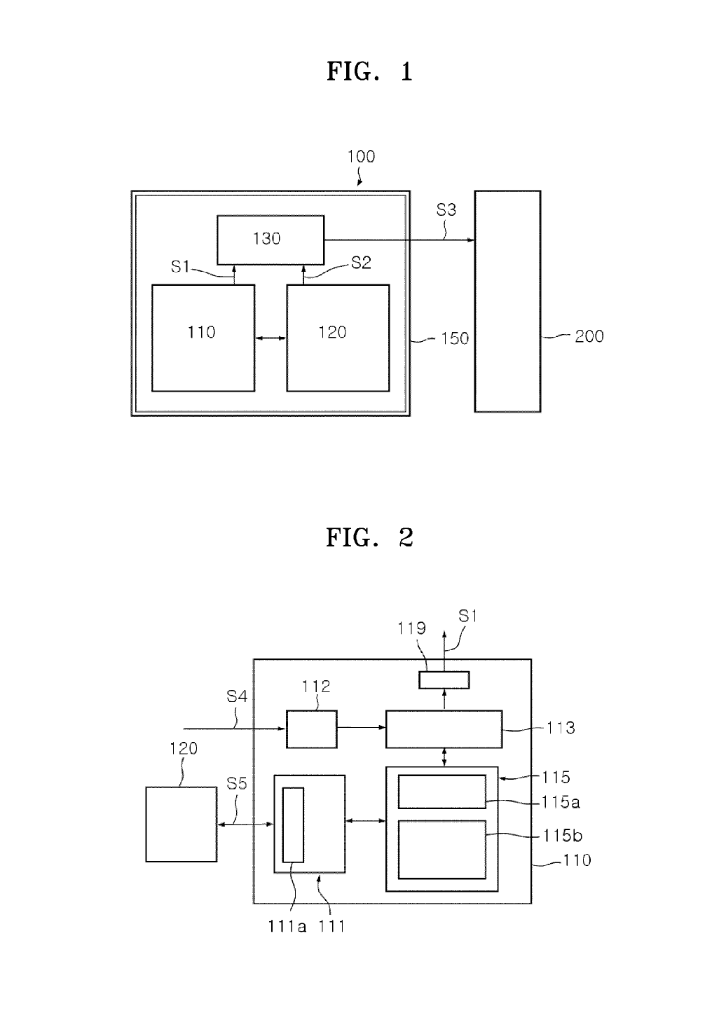

FIG. 1 illustrates an example of a multimedia device 100.

Referring to FIG. 1, the multimedia device 100 includes a multimedia signal processing apparatus 110, an Optical Disc Drive (ODD) apparatus 120, and an output switch 130. The multimedia device 100 is connected to a multimedia output apparatus 200 that may be used to display the multimedia. For example, the multimedia device 100 may be incorporated into the same device as the multimedia output apparatus, or they may be separate devices.

The multimedia signal processing apparatus 110 may output a first multimedia signal S1 according to an Operating System (OS). For example, the multimedia signal processing apparatus 110 may perform the function of a multimedia device, such as an Audio-Video (AV) device, a set-top box, a smart TV, a device in which smart functions (e.g., the Internet, games, and Social Network Services (SNSs)) are installed, and the like.

The ODD apparatus 120 may process data acquired from an optical disc and may output a second multimedia signal S2.

In this example, each of the first and second multimedia signals S1 and S2 is a signal that may be directly output by the multimedia output apparatus 200 without decoding a non-compressed video signal and may be a non-compressed digital video signal satisfying a display interface standard.

For example, each of the first and second multimedia signals S1 and S2 may be a digital AV signal that satisfies the High Definition Multimedia Interface (HDMI) standard or a digital video signal that satisfies the Digital Visual Interface (DVI) standard. As another example, each of the first and second multimedia signals S1 and S2 may be a digital AV signal that satisfies the DisplayPort (DP) standard. As another example, each of the first and second multimedia signals S1 and S2 may be an analog video signal that satisfies the Video Graphics Array (VGA) standard.

The output switch 130 may receive the first multimedia signal S1 output from the multimedia signal processing apparatus 110 and the second multimedia signal S2 output from the ODD apparatus 120 and selectively output any one the first and second multimedia signals S1 and S2 as a multimedia signal S3. For example, the output switch 130 may output the multimedia signal S3 based on a user's selection. The multimedia signal S3 output from the output switch 130 may be transmitted to the multimedia output apparatus 200.

When the first multimedia signal S1 is selected by the output switch 130, a Graphic User Interface (GUI) based on the OS of the multimedia signal processing apparatus 110 may be provided to the multimedia output apparatus 200.

As another example, when the second multimedia signal S2 is selected by the output switch 130, the second multimedia signal S2 output from the ODD apparatus 120 is directly output to the multimedia output apparatus 200. In this example, the multimedia output apparatus 200 operates separately from the ODD apparatus 120. In addition, the GUI based on the OS of the multimedia signal processing apparatus 110 is not provided to the multimedia output apparatus 200.

The output switch 130 may be disposed separately from the multimedia signal processing apparatus 110 and may be controlled independently, but is not limited thereto. In various aspects, the output switch 130 may be controlled based on the OS of the multimedia signal processing apparatus 110. The multimedia signal processing apparatus 110, the ODD apparatus 120, and the output switch 130 may be accommodated in a single housing 150.

The multimedia output apparatus 200 may be a display device that includes a display panel and a driving unit for driving the display panel. The multimedia signal S3 that is transmitted by the output switch 130 may be non-compressed video signal. In this example, the multimedia signal S3 may be directly output (that is, displayed) by the multimedia output apparatus 200 without decoding. Accordingly, the multimedia output apparatus 200 may not have a decoder.

The multimedia output apparatus 200 may include a terminal that satisfies display interface standards, such as HDMI, DVI, DP, and/or VGA, and may output a multimedia signal that satisfies the display interface standard, such as HDMI, DVI, DP, and/or VGA. The multimedia output apparatus 200 may further include a sound output device, such as a speaker. For example, the multimedia output apparatus 200 may be a display device for outputting a digital AV signal satisfying the HDMI standard.

FIG. 2 illustrates an example of the multimedia signal processing apparatus 110.

Referring to FIG. 2, the multimedia signal processing apparatus 110 includes an ODD controller 111 that may control the ODD apparatus 120, a main interface 112 that may receive raw data S4 from an outside source, a main decoder 113 that may decode the raw data received through the main interface 112, an Operating System Device (OSD) 115 that may provide an operating environment of the ODD controller 111 and the main decoder 113 based on the OS, and a first output interface 119 that may output a first multimedia signal S1 processed by the main decoder 113.

For example, the ODD controller 111 may control the ODD apparatus 120 through an ODD master interface 111a. The ODD master interface 111a may be a terminal (or connection device) for transmitting and receiving data S5 to and from the ODD apparatus 120. For example, the ODD master interface 111a may include a Universal Serial Bus (USB) interface, a Parallel Advanced Technology Attachment (RATA) interface, a Serial Advanced Technology Attachment (SATA) interface, and the like. The data S5 that is input or output through the ODD master interface 111 a may be information or a control signal for controlling the ODD apparatus 120. The ODD controller 111 is not limited to the format or specification of the ODD master interface 111a, and interface methods, such as USB, ATA, and SATA, may be used instead.

The main decoder 113 may include hardware codecs and software codecs and may individually extract (or decode) an AV signal (the first multimedia signal S1) from the raw data S4 received from the outside in a wired or wireless manner. Data is input to the main interface 112 and output to the outside. The data may include at least one of, for example, USB, PATA, SATA, flash media, Ethernet, Wi-Fi, Bluetooth, and the like. As an example, the raw data S4 received from the outside may be TV broadcast data that is input in a broadcasting wave or cable format, Internet Protocol Television (IPTV) broadcast data that is input through a line, such as the Internet, and the like. The raw data S4 may be compressed in various codec standards. For example, a data compression method thereof may include lossy compression and lossless compression.

The decoding by the main decoder 113 may be distributedly supported by a Multi-Functional Codec (MFC) decoder chip and software codecs. In an example in which codecs are distributedly supported, some codecs may be supported by a hardware codec device, such as an MFC, and other codecs may be supported by software codecs loaded in a Random Access Memory (RAM). As such, codecs that are supported in a software form may be able to be registered and upgraded in a storage device (not shown) of the multimedia signal processing apparatus 110, e.g., a Hard Disk Drive (HDD) or a flash memory, through a program installing process. The application of software codecs may consider loads of system hardware providing a base of the OS of the OSD 115. Some of a plurality of codecs corresponding to a plurality of multimedia data standards may be included in both hardware codecs and software codecs. In some examples, all codecs may be included in both hardware codecs and software codecs. As another example, all codecs may be supported by only software codecs. As another example, all codecs may be supported by only hardware codecs.

The OSD 115 includes a Central Processing Unit (CPU) 115a and a memory 115b. The CPU 115a provides an operating environment that is based on the OS and may use a CPU used in Personal Computers (PCs). For example, the operating environment of the ODD controller 111, which is provided by the OSD 115, may be provided on the GUI.

For example, the OSD 115 may provide the operating environment of the ODD controller 111 and the main decoder 113 and an operating environment of software and hardware for executing smart functions, such as the Internet, games, and SNSs. The multimedia device 100 may decode data read by the ODD apparatus 120 via the ODD apparatus 120, so a computation load of the CPU 115a can be reduced, thereby reducing the number of parts of the CPU 115a and reducing manufacturing costs of the multimedia device 100. The memory 115b may include boot Read Only Memory (ROM), RAM, and a memory for storing the GUI and the software codecs, e.g., a flash memory or an HDD.

The first output interface 119 transmits the first multimedia signal S1 decoded by the main decoder 113 to the output switch 130. As described above, the first multimedia signal S1 may be a non-compressed digital video signal that satisfies a display interface standard, and thus, the first output interface 119 may be an interface that satisfies the display interface standard of the first multimedia signal S1. For example, if the first multimedia signal S1 is a digital AV signal satisfying the HDMI standard, the first output interface 119 is an HDMI terminal.

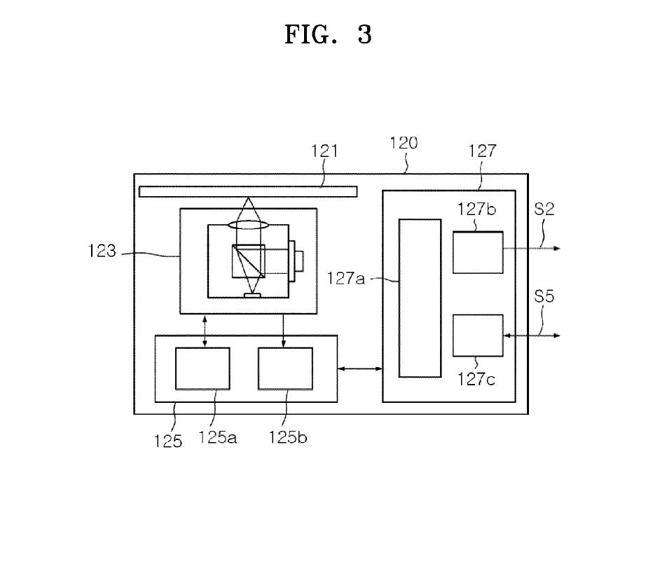

FIG. 3 illustrates an example of the ODD apparatus 120.

Referring to FIG. 3, the ODD apparatus 120 includes an optical pickup 123 for reading information from an optical disc 121, a front-end module 125, and a back-end module 127.

The optical pickup 123 may include a driving device (not shown) for loading and driving the optical disc 121 and an optical module (not shown) for radiating light and reading reflected light. As an example, the optical disc 121 may be a Digital Versatile Disc (DVD), a Blu-ray Disc (BD), a compact disc (CD) and the like. For example, the optical pickup 123 may drive a BD or may be designed to be compatible with a CD or DVD.

The front-end module 125 may include a servo controller 125a for controlling a tracking and focusing mechanism of the optical pickup 123 and an RF signal processor 125b for processing an RF signal received from the optical pickup 123. The RF signal processor 125b may include an RF amplifier (not shown) for amplifying a high-frequency analog signal that is read by the optical pickup 123, an Analog/Digital (A/D) converter (not shown) for converting a signal amplified by the RF amplifier to a digital signal, an error corrector (not shown), a variable transfer rate controller (not shown), and a data separator (not shown).

In the example of FIG. 3, the back-end module 127 includes an ODD decoder 127a for decoding the digital signal received from the front-end module 125 into the second multimedia signal S2, a second output interface 127b outputting the second multimedia signal S2, and an ODD slave interface 127c connecting to the multimedia signal processing apparatus 110.

The ODD decoder 127a may include hardware codecs and software codecs and may extract (or decode) an AV signal (the second multimedia signal S2) from digital data, i.e., raw data, received from the front-end module 125. For example, the ODD decoder 127a may include an audio unit (not shown) and a video unit (not shown) for processing the digital data received from the front-end module 125 as an audio signal and a video signal, respectively. The ODD decoder 127a may also include various standards of codecs for coding and decoding various kinds of content provided in an optical disc form. For example, the standards may include MPEG2, H.264, VC-1, and the like. A codec compresses audio and video data. Accordingly, the performance of the codec depends on how long the data is reproduced with a limited storage space and high resolution. For example, a data compression method includes lossy compression and lossless compression.

The second output interface 127b transmits the second multimedia signal S2 decoded by the ODD decoder 127a to the output switch 130. As described above, the second multimedia signal S2 may be a non-compressed video signal that satisfies a display interface standard such as HDMI, DVI, DP, VGA, and the like. Accordingly, the second output interface 127b may be an interface that satisfies the display interface standard of the second multimedia signal S2. For example, if the second multimedia signal S2 is a digital AV signal satisfying the HDMI standard, the second output interface 127b is an HDMI terminal.

The ODD slave interface 127c is a terminal that transmits and receives data S5 to and from the ODD master interface 111a of the multimedia signal processing apparatus 110. For example, the ODD slave interface 127 c may be USB, ATA, SATA, and the like.

According to various aspects, by directly decoding and outputting data acquired by an ODD apparatus in a multimedia device, a load of an OSD in the multimedia device can be reduced in the case of decoding high-resolution and high-definition video, thereby stabilizing a system.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multimedia device comprising:
a multimedia signal processing apparatus configured to decode data input from an outside source based on an Operating System (OS) and to output the decoded data as a first multimedia signal;
an Optical Disc Drive (ODD) apparatus configured to acquire data from an optical disc, to decode the acquired data, and to output the decoded data as a second multimedia signal; and
an output switch configured to receive the first multimedia signal and the second multimedia signal and to selectively output one of the first multimedia signal and the second multimedia signal.

2. The multimedia device of claim 1, wherein the first and second multimedia signals each satisfy a display interface standard.

3. The multimedia device of claim 2, wherein the display interface standard comprises at least one of a High Definition Multimedia Interface (HDMI) standard, a Digital Visual Interface (DVI) standard, a DisplayPort (DP) standard, and a Video Graphics Array (VGA) standard.

4. The multimedia device of claim 1, wherein the multimedia signal processing apparatus, the ODD apparatus, and the output switch are accommodated in a single housing.

5. The multimedia device of claim 1, wherein the multimedia signal processing apparatus comprises:
an ODD controller configured to control the ODD apparatus;
a main interface configured to receive raw data from the outside source;
a main decoder configured to process input multimedia data to decode the input multimedia data into the first multimedia signal;
an Operating System Device (OSD) configured to provide an operating environment of the ODD controller and the main decoder based on the OS; and
a first output interface configured to output the first multimedia signal processed by the main decoder.

6. The multimedia device of claim 5, wherein the ODD controller comprises an ODD master interface configured to transmit and receive data to and from the ODD apparatus.

7. The multimedia device of claim 6, wherein the ODD master interface comprises at least one of a Universal Serial Bus (USB) interface, an Advanced Technology Attachment (ATA) interface, and a Serial Advanced Technology Attachment (SATA) interface.

8. The multimedia device of claim 5, wherein the main interface comprises at least one of a USB interface, a Parallel ATA (PATA) interface, a SATA interface, a flash media interface, an Ethernet interface, a Wi-Fi interface, and a Bluetooth interface.

9. The multimedia device of claim 5, wherein the main decoder comprises at least one of hardware codecs and software codecs corresponding to a plurality of multimedia data standards.

10. The multimedia device of claim 5, wherein the OSD comprises a Central Processing Unit (CPU) and a memory for providing the operating environment of the ODD controller and the main decoder based on the OS.

11. The multimedia device of claim 5, wherein the first output interface satisfies at least one of the HDMI interface standard, the DVI standard, the DP standard, and the VGA standard.

12. The multimedia device of claim 1, wherein the ODD apparatus comprises:
an optical pickup configured to read a signal from an optical disc;
a front-end module configured to control the optical pickup and processing the signal read by the optical pickup into a digital signal; and
a back-end module configured to decode the digital signal processed by the front-end module and output the decoded digital signal as the second multimedia signal.

13. The multimedia device of claim 12, wherein the front-end module comprises:
a servo controller configured to control the optical pickup; and
a Radio Frequency (RF) signal processor configured to convert an RF signal read by the optical pickup to a digital signal.

14. The multimedia device of claim 12, wherein the back-end module comprises:
an ODD decoder configured to decode the digital signal received from the front-end module into the second multimedia signal; and
a second output interface configured to output the second multimedia signal.

15. The multimedia device of claim 14, further comprising a multimedia output apparatus configured to receive a multimedia signal selected by and output from the output switch.

16. The multimedia device of claim 15, wherein the multimedia output apparatus comprises a terminal satisfying at least one of the HDMI interface standard, the DVI standard, the DP standard, and the VGA standard.

17. A smart TV comprising:
a broadcast data processing apparatus configured to broadcast data input from an outside source based on an Operating System (OS) and to output the decoded broadcast data as a first multimedia signal;
an Optical Disc Drive (ODD) apparatus configured to acquire data from an optical disc, to decode the acquired data, and to output the decoded data as a second multimedia signal;
an output switch configured to receive the first multimedia signal and the second multimedia signal and to selectively output one of the first multimedia signal and the second multimedia signal; and
a display and audio output apparatus configured to receive the multimedia signal selected by and output from the output switch and to render the multimedia.

18. The smart TV of claim 17, wherein the first and second multimedia signals satisfy at least one of a High Definition Multimedia Interface (HDMI) standard, a Digital Visual Interface (DVI) standard, a DisplayPort (DP) standard, and a Video Graphics Array (VGA) standard.

19. An optical disc drive for a multimedia device, the optical disc drive comprising:
an optical pickup configured to read information from an optical disc;
a front-end module configured to process a radio frequency (RF) signal received from the optical pickup; and
a back-end module configured to decode a processed digital signal received from the front-end module to generate a multimedia signal.

20. The optical disc drive of claim 19, wherein the multimedia signal generated by the back-end module is in a format that is capable of being rendered by the multimedia device without further processing by a central processing unit (CPU) of the multimedia device.
